(19) United States
(12) Patent Application Publication
(10) Pub. No.: US 2018/0086009 A1
(43) Pub. Date: Mar. 29, 2018

(54) METHOD FOR MANUFACTURING PLASTIC PRODUCTS USING 3D PRINTER

(71) Applicant: Hyundai Motor Company, Seoul (KR)

(72) Inventors: Young Ho CHOI, Seongnam-Si (KR); Hee Joon LEE, Seoul (KR)

(73) Assignee: Hyundai Motor Company, Seoul (KR)

(21) Appl. No.: 15/375,631

(22) Filed: Dec. 12, 2016

(30) Foreign Application Priority Data
Sep. 23, 2016 (KR) 10-2016-0122075

(51) Int. Cl. B29C 69/02; B33Y 10/00; B33Y 70/00; B33Y 30/00; B29C 45/00; B33Y 80/00; B29C 67/00

(52) U.S. Cl. CPC B29C 69/02; B33Y 10/00; B33Y 70/00; B33Y 30/00; B29K 2105/165; B33Y 80/00; B29C 45/0053; B29C 67/0085; B29C 67/0074; B29C 45/0025

(57) ABSTRACT

A method for manufacturing plastic products using a 3D printer is provided, wherein the method may be configured for improving appearance quality by suppressing a sink mark and improving strength of a fastening structure, by firstly injection-molding a body of a plastic product using an injection molding method and secondly printing the fastening structure of the body using a 3D printer.

### CROSS-REFERENCE TO RELATED APPLICATION

The present application claims priority to Korean Patent Application No. 10-2016-0122075 filed on Sep. 23, 2016, the entire contents of which is incorporated herein for all purposes by this reference.

### BACKGROUND

### Field of the Invention

The present invention relates to a method for manufacturing plastic products using a 3D printer, and more particularly, to a method for manufacturing plastic products using a 3D printer including a process of firstly injection-molding a body of a plastic product and a process of secondly printing a connection structure of the body by using a 3D printer.

### Description of Related Art

Generally, as a method of manufacturing plastic products and the like for a vehicle, representatively, an injection molding method has been used.

In an area where a thickness of the plastic product manufactured by the injection molding method is locally increased or an area where a fastening structure (a rib, a boss, a hook, etc) is integrally formed on the inner surface, there is a disadvantage that a sink mark caused by shrinkage in a cooling solidifying process occurs.

For example, as illustrated in FIG. 1, when a fastening structure 16 is integrally formed on the inner surface of a body 12 of the plastic product 10, there is a disadvantage in that a sink mark 18 caused by shrinkage in a cooling solidifying process occurs on an outer surface of the body 12.

In order to prevent the sink mark, there is a method of limiting the size of the fastening structure (a rib, a boss, a hook, etc.) formed on the inner surface of the plastic product or a method of firstly integrally molding a primary structure (for example, a dog house-shaped structure) with a small thickness in the plastic product and secondly molding the fastening structure on the primary structure. However, when the size of the fastening structure is small, fastening force may deteriorate, and thus there is a disadvantage that the number of fastening structures is excessively increased and there are many limitations including an increase in the entire thickness of the component and the like.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for manufacturing plastic products using a 3D printer capable of improving appearance quality by suppressing a sink mark and improving strength of a fastening structure, by firstly injection-molding a body of a plastic product using an injection molding method and then secondly printing the fastening structure of the body using a 3D printer.

Various aspects of the present invention are directed to providing a method for manufacturing a plastic product using a 3D printer including: i) injection-molding a body of a plastic product by an injection-molding method; ii) coating a compatibilizing agent having adhesion on a surface where the fastening structure of the body is to be formed; and iii) 3D printing the fastening structure on the surface coated with the compatibilizing agent of the body by using the 3D printer.

In an exemplary embodiment, in step i), a bead may be integrally injection-molded on the body of the plastic product to detect a position for 3D printing the fastening structure by an image sensor which is separately mounted on the 3D printer.

In another exemplary embodiment, the bead may be formed with a height H and a width W of 0.07 to 0.13 mm.

In still another exemplary embodiment, the compatibilizing agent may selectively use at least one of epoxy-based, urethane-based, urethane acrylate-based, silane-based, vinyl ester-based, cyanoacrylate-based compounds according to kinds of plastic.

In still yet another exemplary embodiment, the compatibilizing agent may be coated with a thickness of 5 to 100 μm.

In a further exemplary embodiment, an inorganic filler may be mixed with a plastic resin which is a material for 3D printing the fastening structure.

In another further exemplary embodiment, the inorganic filler may be glass bubbles.

Various aspects of the present invention are directed to providing the following effects through the above technical solution.

First, it is possible to improve appearance quality by suppressing a sink mark by firstly injection-molding a body of a plastic product using an injection molding method and secondly printing the fastening structure of the body using a 3D printer.

Second, it is possible to improve breaking strength by mixing an inorganic filter and the like with a plastic resin for 3D-printing the fastening structure.

Other aspects and exemplary embodiments of the invention are discussed infra.

It is understood that the term “vehicle” or “vehicular” or other similar term as used herein is inclusive of motor vehicles in general including passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating an example in which a sink mark is formed on a plastic product;

FIG. 2 and FIG. 3 are schematic diagrams illustrating a method for manufacturing a plastic product using a 3D printer according to an exemplary embodiment of the present invention;

FIG. 4, FIG. 5 and FIG. 6 are schematic diagrams illustrating appearance of printing a fastening structure of the plastic product by using a 3D printer according to an exemplary embodiment of the present invention; and

FIG. 7 and FIG. 8 are cross-sectional views illustrating a plastic product using a 3D printer according to an exemplary embodiment of the present invention.

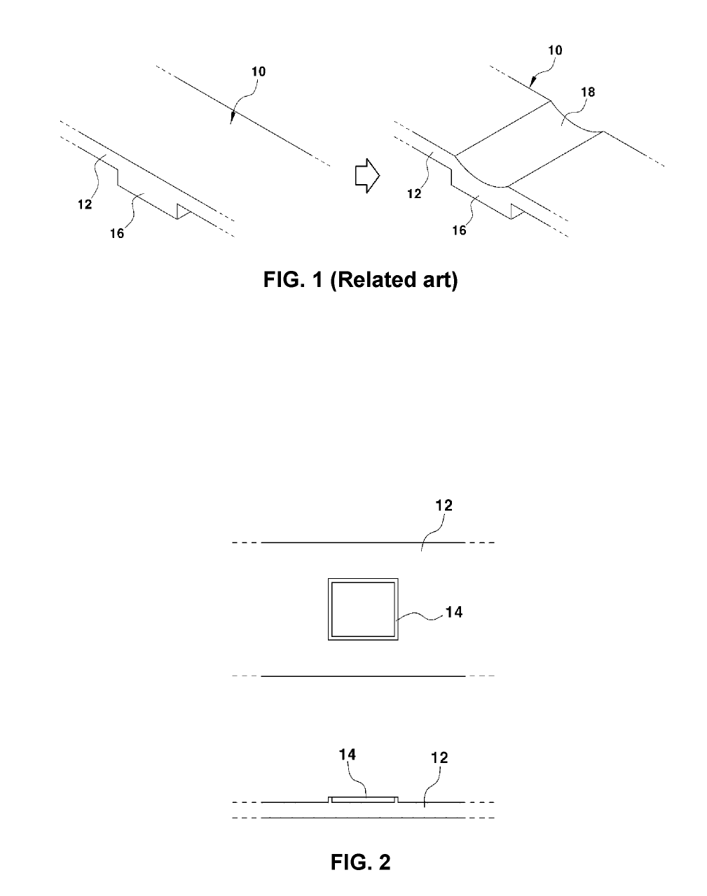

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described in detail with reference to the accompanying drawings.

The present invention places emphasis on improving appearance quality by suppressing a sink mark and improving strength of a fastening structure, by injection-molding a body of a plastic product (for example, a garnish mounted on an outside surface of a door panel of a vehicle) using an injection molding method and then printing the fastening structure (a hook or a clip fastened to the door panel, a rib or a boss for reinforcing strength, or the like) of the body using a 3D printer.

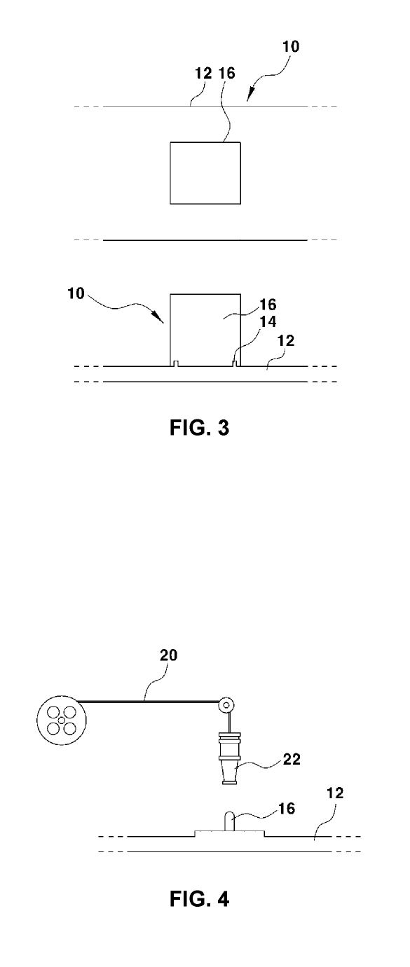

FIG. 2 and FIG. 3 illustrate a method for manufacturing a plastic product using a 3D printer according to an exemplary embodiment of the present invention in sequence.

First, a body 12 of a plastic product 10 is injection-molded by using a general injection-molding method.

In the instant case, when the body 12 of the plastic product 10 is injection-molded, a bead 14 is integrally injection-molded on an inside surface of the body 12 together.

The bead 14 is a kind of identification mark which can be detected by an image sensor separately mounted on the 3D printer and formed in a similar shape (for example, a square-ring shape) to a shape of a lower circumferential portion of the fastening structure to be formed on the surface of the body 12 as illustrated in FIG. 2.

As a result, a coordinate position for 3D printing a fastening structure 16 on the inside surface of the body 12 in the 3D printer may be easily set by detecting the bead 14 in the image sensor separately mounted on the 3D printer.

In more detail, in the related art, since a coordinate of a new print matter is reset by installing a separate dedicated jig on a die part of the 3D printer, there is difficulty with jig production and resetting a reference coordinate. However, in an exemplary embodiment of the present invention, since a 3D printing coordinate position of the fastening structure 16 which is a new print article may be easily set by recognizing the bead 14 injection-molded on the inside surface of the body 12 together by the image sensor to largely reduce a lead time (a dedicated jig producing and coordinate resetting time in the related art).

A height H and a width W of the bead 14 are formed with 0.07 to 0.13 mm. The reason is that when the height and the width of the bead is smaller than 0.07 mm, it is difficult to recognize the bead in the image sensor, and when the height and the width of the bead is larger than 0.13 mm, a 3D printing hindrance for the fastening structure or the damage to the fastening structure may be caused.

Next, a compatibilizing agent for improving adhesion with the fastening structure 16 is coated on a surface where the fastening structure 16 of the body 12 is to be formed, that is, a surface when the bead 14 of the body 12 is detected.

The compatibilizing agent may selectively use at least one of epoxy-based, urethane-based, urethane acrylate-based, silane-based, vinyl ester-based, cyanoacrylate-based compounds according to kinds of plastic.

The compatibilizing agent is coated with a thickness of 5 to 100 μm. The reason is that when the thickness is less than 5 μm, adhesion reliability on an interface between the body 12 which is a basic material and the fastening structure 16 which is a new 3D printing article may not be ensured, and when the thickness is more than 100 μm, the compatibilizing agent acts as a pollutant or acts as an element delaying a printing time during 3D printing.

Next, as illustrated in FIG. 3, 3D-printing the fastening structure 16 on the surface of the body 12 on which the compatibilizing agent is coated is performed by using the 3D printer.

In more detail, after the printing coordinate of the fastening structure is set by recognizing the bead 14 in the image sensor of the 3D printer, the fastening structure 16 is 3D-printed by using the same plastic resin powder as the body 12 in the 3D printer.

An inorganic filler (for example, glass bubbles) was mixed and used with a plastic resin powder which is a material for 3D-printing the fastening structure 16 to largely improve breaking strength of the fastening structure.

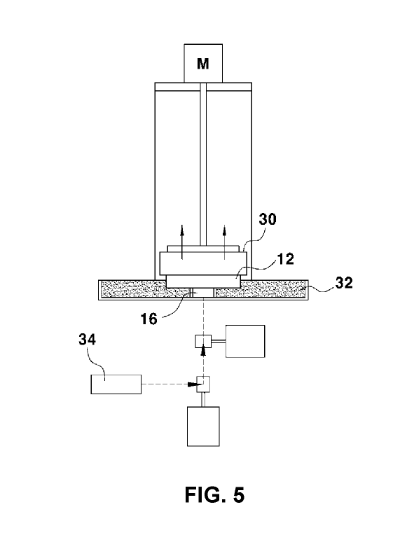

Meanwhile, the 3D printer used in the 3D printing step may use a material jet type 3D printer which supplies a plastic filament 20 to a heating nozzle 22, melts the plastic filament 20 in the heating nozzle 22 and simultaneously ejects the plastic filament 20 to the surface of the body 12 of the plastic product 10 as illustrated in FIG. 4.

Alternatively, as illustrated in FIG. 5, the 3D printer may use a photopolymerization type 3D printer including a holder 30 holding elevatably the body 12 of the injection-molded plastic product, a container 32 in which a photocurable resin is contained, a laser or UV irradiation device 34 to laminate the photocurable resin to the fastening structure 16 of the body 12 by irradiating laser or UV to a part contacting the photocurable resin, and the like.

Alternatively, the 3D printer may use a powder bed fusion type 3D printer including a storage chamber 40 in which the plastic resin is stored in a powder form, a processing chamber 42 which is a space molded by repetitively laminating the fastening structure 16 on the surface of the body 12 of the plastic product 10 by the 3D printing method several times, a roller 44 pushing and transferring the powder stored in the storage chamber 40 to the processing chamber 42, a laser or UV irradiation device 46 curing the plastic resin powder by irradiating the laser or the UV to the plastic resin powder filed on the body 12, and the like.

Accordingly, appearance quality may be improved by suppressing the sink mark of the final plastic product and breaking strength may be largely improved by mixing an inorganic filler and the like to the plastic resin for 3D printing the fastening structure, by firstly injection-molding the body 12 of the plastic product 10 by using an injection molding method and secondly printing the fastening structure 16 of the body 12 by using the 3D printer.

### EXAMPLES

Herein, the present invention will be described in more detail through Examples.

### Example 1

A center filler garnish for a vehicle as a plastic product was manufactured by a general plastic injection molding method to be manufactured in a structure where a bead detectable in the image sensor of the 3D printer is integrally formed and then urethane acrylate as the compatibilizing agent is coated on an inside surface (a surface on which the bead is formed and a fastening structure is to be formed) of the center filler garnish with a thickness of 10 μm.

Subsequently, the fastening structure was 3D-printed on the inside surface (the surface coated with the urethane acrylate) of the center filler garnish by using the same plastic resin powder as the center filler garnish.

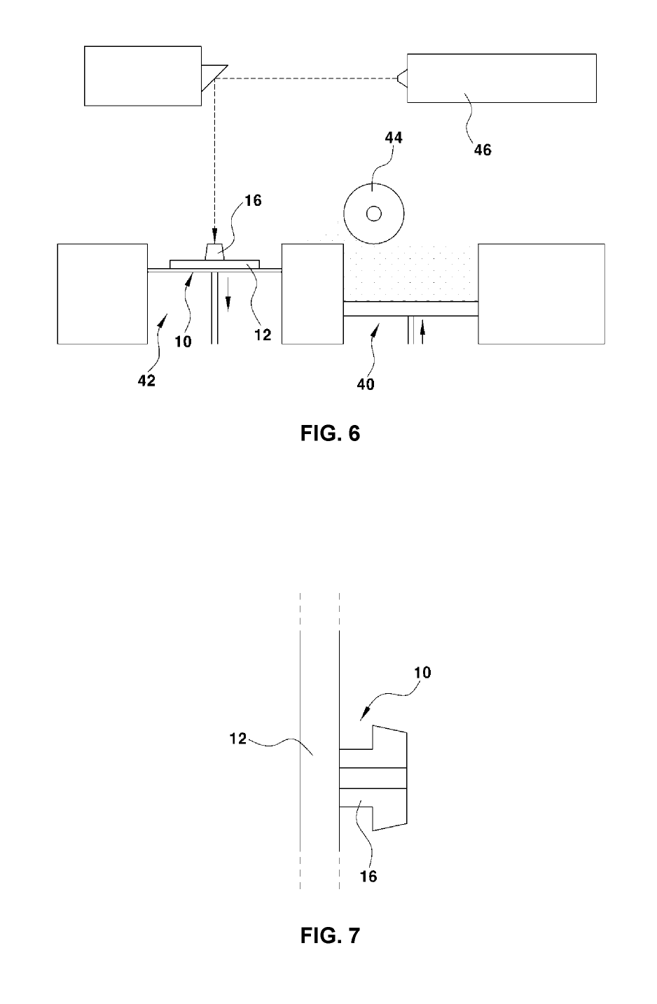

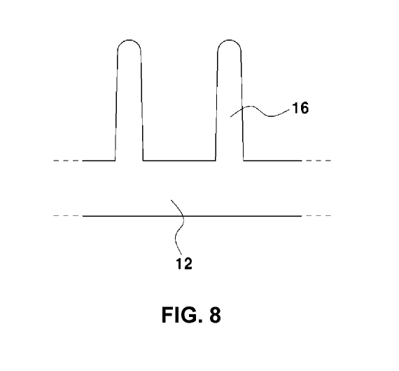

In other words, a hook (see FIG. 7) or a rib (see FIG. 8) as the fastening structure was 3D-printed on the surface of the center filler garnish coated with the urethane acrylate by using the material jet type 3D printer.

### Example 2

A center filler garnish for a vehicle was manufactured by the same method as Example 1, but manufactured by using the photo polymerization type 3D printer as the 3D printer.

### Example 3

A center filler garnish for a vehicle was manufactured by the same method as Example 1, but, as the 3D printer, the powder bed fusion type 3D printer was used, and glass bubbles having an average diameter of 20 μm and true density of 0.46 g/cm³ were mixed and used with plastic resin powder with a weight ratio of 20%.

### Comparative Example 1

A center filler garnish having a fastening structure (a hook and a rib) was manufactured by using only a plastic injection molding method.

### Comparative Example 2

A center filler garnish was manufactured by the same method as Example 1 and a 3D printer coordinate was reset manually by manufacturing a dedicated jig in the related art without integrally forming the bead when injection-molding the center filler garnish and then the hook as the fastening structure was 3D-printed.

### Comparative Example 3

A center filler garnish was manufactured by the same method as Example 1 and a fastening hook was 3D-printed in a state where a compatibilizing agent was not coated.

### Comparative Example 4

A center filer garnish was manufactured by the same method as Comparative Example 1, and to suppress a sink mark, a thickness of a fastening hook was increased to 0.6 mm and to compensate for fastening strength, the number of fastening hooks was increased to five.

### TEST EXAMPLES

Breaking strength (a load value when the center filler was fastened to a vehicle body and then the hook was deformed or damaged during detaching) of the fastening hooks in Examples 1 to 3 and Comparative Examples 1 to 4 was measured and whether a sink mark was present was tested by the naked eyes, and then the result was disclosed in Table 1 below.

TABLE 1

| | Example | Example | Example | Comparative | Comparative | Comparative | Comparative |
|---|---|---|---|---|---|---|---|
| | 1 | 2 | 3 | Example 1 | Example 2 | Example 3 | Example 4 |
| 1. Thickness | 2 | 2 | 1.5 | 1 | 2 | 2 | 0.6 |
| of fastening | | | | | | | |
| hook (mm) | | | | | | | |
| 2. Number of | 3 | 3 | 3 | 3 | 3 | 3 | 5 |
| hooks | | | | | | | |
| 3. Breaking | 65 | 67 | 100 | 30 | 65 | 17 | 19 |
| strength of | | | | | | | |
| fastening | | | | | | | |
| portion (kgf) | | | | | | | |
| 4. Number of | 0 | 0 | 0 | 2 | 0 | 0 | 0 |
| sink marks | | | | | | | |
| 5. Minimal | No | No | No | 4 | No | No | 4 |
| frost of rib | limitation | limitation | limitation | | limitation | limitation | |
| without sink | | | | | | | |
| mark (mm) | | | | | | | |
| 6. Assembly | 0.05 | 0.03 | 0.02 | 5 | 0.05 | 27 | 8 |
| error rate (%) | | | | | | | |
| 7. Lead time | 0 | 0 | 0 | 7 | 7 | 7 | 7 |
| (day) | | | | | | | |

As illustrated in Table 1 above, in Examples 1 to 3, it can be seen that there is no sink mark to improve appearance quality and breaking strength of the hook is as compared with Comparative Examples 1 to 4, and it can be seen that an assembly/fastening error rate for the vehicle body is low due to the absence of the sink mark and improvement of the breaking strength.

Furthermore, in Example 3, a fastening hook was reinforced by mixing a mineral filler (glass bubbles) with plastic resin powder that 3D-prints the fastening hook to realize higher mechanical strength and reliability.

On the contrary, in the case of a garnish molded together with fastening hook by a plastic injection method, a sink mark was observed on an appearance by molding shrinkage and an interval between hooks is also limited and thus it is difficult to design a free shape for optimizing structural strength.

In Comparative Example 2, to reset a 3D coordinate value of a product for 3D printing to a working table (die) which is a reference coordinate set in the 3D printer, it is determined that a preparing time for manufacturing a separate dedicated jig and manually resetting a coordinate is required and a lead time is increased and thus productivity is reduced.

Further, in Comparative Example 3, like each Example, it can be seen that a garnish ensuring appearance quality may be manufactured by the 3D printing process, but adhesion strength of an interface between the garnish body and the hook is insufficient since the compatibilizing agent is not coated and thus breaking strength of the hook is decreased.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for manufacturing a plastic product using a 3D printer, the method comprising:
i) injection-molding a body of a plastic product by an injection-molding method;
ii) coating a compatibilizing agent having adhesion on a surface where a fastening structure of the body is to be formed; and
iii) 3D printing the fastening structure on the surface coated with the compatibilizing agent of the body by using the 3D printer.

2. The method of claim 1, wherein in step i), a bead is integrally injection-molded on the body of the plastic product to detect a position for 3D printing the fastening structure by an image sensor which is separately mounted on the 3D printer.

3. The method of claim 2, wherein the bead is formed with a height and a width of 0.07 to 0.13 mm.

4. The method of claim 1, wherein the compatibilizing agent selectively uses at least one of epoxy-based, urethane-based, urethane acrylate-based, silane-based, vinyl ester-based, cyanoacrylate-based compounds according to a kind of plastic.

5. The method of claim 1, wherein the compatibilizing agent is coated with a thickness of 5 μm to 100 μm.

6. The method of claim 1, wherein an inorganic filler is mixed with a plastic resin which is a material for 3D printing the fastening structure.

7. The method of claim 6, wherein the inorganic filler is glass bubbles.
